(19) United States
(12) Patent Application Publication
(10) Pub. No.: US 2010/0152065 A1
(43) Pub. Date: Jun. 17, 2010

(54) PRODUCTION METHOD OF PARTICLE ARRAY

(75) Inventors: Motoi NISHIMURA, Tokyo (JP); Tatsuya NAGASE, Tokyo (JP); Aya SHIRAI, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/632,294

(22) Filed: Dec. 7, 2009

(30) Foreign Application Priority Data
Dec. 12, 2008 (JP) 2008316562

(51) Int. Cl. C40B 50/08

(52) U.S. Cl. 506/27

(57) ABSTRACT

A method of producing a particle array is disclosed, comprising allowing monodisperse particles to be arrayed in an aqueous medium containing a monomer to form a colloidal crystal exhibiting a structural color and then polymerizing the monomer to form a polymer.

This application claims priority from Japanese Patent Application No. 2008-316562, filed on Dec. 12, 2008, which is incorporated hereinto by reference.

### FIELD OF THE INVENTION

The invention relates to a production method of a particle array exhibiting a structural color.

### BACKGROUND OF THE INVENTION

It is known that a colloidal crystal which yields Bragg's reflection created by regular array of monodispersed particles can be employed for a photonic material, a coloring material, a color display material and a reflection plate. Recently, there have been extensively made studies to obtain a colloidal crystal, as described in, for example, JP 2005-279633A and Yoshinaga et al., “Kobunshi Ronbunshu” vol. 64, No. 1, pp. 21-28, 2007.

A regular array of particles in a colloidal crystal is usually formed in the presence of water, as disclosed in JP 2005-325173A. Immobilization of arrayed particles is conducted in such a manner that an immobilization treatment (first step immobilization treatment) is performed in the presence of water to fix the three-dimensional position of particles and in this stage a water-removing treatment is conducted to inhibit performance variation caused by evaporation of water with time and since there are produced problems such as light scattering due to voids formed by removal of water, a treatment to fill a new immobilizing agent (second step immobilization treatment) is conducted to fill up such voids.

### SUMMARY OF THE INVENTION

However, there are problems such that it concerns that when subjected to two-stepped immobilization treatments including water removal and filling a new immobilizing agent, thus obtained particle array results in disorder in the array of particles. Further, there is also desired shortening of the production time of a particle array.

The invention has come into being in view of the foregoing problems and it is an object of the invention to provide a method of producing, within a short time, a particle array comprising a colloidal crystal of high quality with no disorder in the array.

One aspect of the invention is directed to a method of producing a particle array, wherein the method comprises the steps of allowing monodisperse particles to be arrayed by using an aqueous medium containing a monomer to form a colloidal crystal exhibiting a structural color and then polymerizing the monomer to a polymer.

In one of the preferred embodiments of the production method of a particle array of the invention, at least one molecule of water per molecule of the monomer is subsumed within a polymer formed along with polymerization of the monomer.

Further, in one of preferred embodiments of the production method of a particle array of the invention, the monomer is an acrylate monomer.

Further, in one of preferred embodiments of the production method of a particle array of the invention, the monomer is ethylene glycol methacrylate or hydroxyethyl methacrylate, or a mixture thereof.

In the production method of a particle array of the invention, monomers in an aqueous medium used in formation of a colloidal crystal are polymerized to fix the colloidal crystal, so that a particle array comprising a high quality colloidal crystal, inhibiting disorder in the array, can be obtained within a short period of time.

Specifically, in the production method in which at least one water molecule per monomer molecule is subsumed within a polymer formed by polymerizing monomers, the number of water molecules to be removed is reduced, rendering it feasible to delay the speed of removing water molecules, whereby disorder in the particle array, which is accompanied by removal of water, is further reduced and consequently a particle array incorporating a colloidal crystal of high quality can be obtained within a short period of time.

### BRIEF DESCRIPTION OF THE DRAWINGS

FIG. 1 illustrates the particle array of the invention before curing; and

FIGS. 2 and 3 illustrate the particle array of the invention after curing.

### DETAILED DESCRIPTION OF THE INVENTION

The invention will be described in detail below.

### Production Method of Particle Array

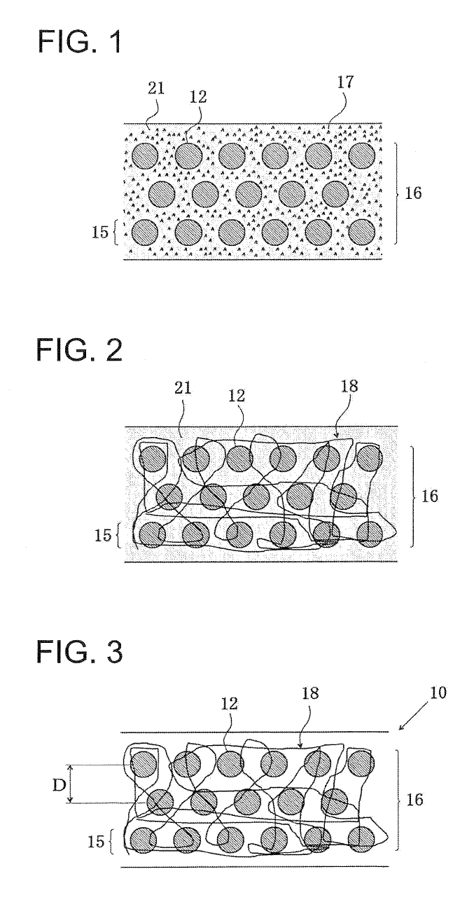

The production method of a particle array comprises allowing monodisperse particles 12 (hereinafter, also denoted simply as particles) to be arrayed to form a colloidal crystal (16) exhibiting a structural color by using an aqueous medium (21) containing at least one monomer (17), and then allowing the monomer (17) to be cured to form a water-absorbing polymer (18), as illustrated in FIGS. 1 and 2.

Specifically as shown in FIG. 3, the thus obtained particle array (10) has a constitution containing a colloidal crystal (16) in which particle layers (15) formed of particles (12) which are orderly arranged in contact with or in non-contact with each other in the layer direction, are provided in the direction of thickness in the state of being in contact or non-contact with each other within a matrix comprised of a water-absorbing polymer (18) in the state of absorbing the water.

In one preferred embodiment of the invention, the colloidal crystal has a structure in which particles are arranged in a single direction with respect to the incident direction of light. Specifically, it is preferred that particles are arrayed so that the colloidal crystal has a closest packing structure.

In the particle array of the invention, a difference in absolute value of refractive index between particles and the matrix is preferably from 0.02 to 2.0, and more preferably from 0.1 to 1.6. A difference in refractive index of not less than 0.02 readily exhibits structural color and a difference in refractive index of not more than 2.0 does not result in milky-whitening of structural color, caused by increased light scattering.

Specifically, the production method of a particle array of the invention comprises preparing a suspension of particles dispersed in an aqueous medium containing a monomer, which is polymerizable to form a water-absorbing polymer, coating the suspension onto the surface of a substrate or the like to form a colloidal crystal in which self-ordered particles are regularly-arrayed, and polymerizing the monomer.

It is preferred to allow an initiator capable of initiating polymerization by, for example, light such as ultraviolet rays or heat to be contained in advance in the aqueous medium without addition of an additive from the external of the reaction system.

An aqueous medium constituting such a suspension contains water preferably in an amount of 50% by mass and may contain a water-soluble organic solvent in an amount of 0-50% by mass. Such a water-soluble organic solvent is not specifically limited if it does not dissolve the particles, including, for example, methanol, ethanol, isopropanol, butanol, acetone, methyl ethyl ketone, and tetrahydrofuran. Of these, an alcoholic organic solvent is preferred. The aqueous medium is more preferably one composed of 100% by mass of water.

A monomer contained in the aqueous medium is not specifically limited and may employ various monomers if it is polymerizable in the aqueous medium and is capable of forming a water-absorbing polymer which can subsume at least one water molecule per molecule of the monomer. Herein, the expression “subsume at least one water molecule per molecule of the monomer” represents that the variation range of a water content along with temperature change is within 10% at a temperature lower than the softening point of the water-absorbing polymer. For example, when such a water-absorbing polymer is dried at a temperature lower that the softening point of the polymer, the difference in water content (in %) between before and after being dried is preferably not more than 10%.

The water content of the particle array of the invention is determined in the manner that 1 g of the particle array is pulverized in a mortar and after evaporating water at 200° C., the water content is measured by the titration method using a Karl Fischer's reagent.

Specifically, a water-absorbing polymer which is obtained by polymerization of such a monomer as described above has a cross-linking structure and exhibits a property of being capable of swelling upon subsuming at least one molecule of water per molecule of the monomer. The water-absorbing polymer can be formed by polymerizing a monomer, for example, a non-crosslinking monomer and a crosslinking monomer (hereinafter, cross-linking monomer).

### Water-Absorbing Polymer

Examples of such the water-absorbing polymer relating to the invention include a cross-linked poly(meth)acrylic acid or poly(meth)acrylate, a cross-linked poly(meth)acrylic acid ester containing a sulfonic acid group, a cross-linked poly(meth)acrylic acid ester containing a polyalkylene group (or chain), a cross-linked poly(meth)acrylamide, a cross-linked polydioxolan, a cross-linked polyethylene oxide, a cross-linked polyvinyl pyrrolidone, a cross-linked poly(sulfonated styrene), a cross-linked polyvinylpyridine, a saponified starch-poly(meth)acrylonitrile copolymer, a starch-poly(meth)acrylic acid or its salt, a cross-linked graft copolymer, a reaction product of a polyvinyl alcohol and an anhydrous maleic acid (or its salt), a cross-linked polyisobutylene-maleic acid salt copolymer, a polyvinyl alcohol sulfonic acid salt and poly[(vinyl alcohol)-co-(acrylic acid)] graft polymer.

### Monomer

Of monomers used for the production method of a particle array of the invention, a non-crosslinkable monomer is preferably a water-soluble monomer.

Specific examples of a water-soluble monomer include acrylic acid, methacrylic acid, itaconic acid, maleic acid, fumaric acid, crotonic acid, citraconic acid, vinylsulfonic acid, (meth)acrylsulfonic acid, 2-(meth)acrylamido-2-methylpropanesulfonic acid, 2-(meth)acryloylethanesulfonic acid, 2-(meth)acryloylpropanesulfonic acid, (meth)acrylsulfonic acid and their alkali metal or ammonium salts; N,N′-dimethylaminoethyl(meth)acrylate and its quaternary salt, (meth)acrylamide, N,N′-dimethyl(meth)acrylamide, 2-hydroxyethyl(meth)acrylamide, 2-hyroxyethyl(meth)acrylate, 2-hydroxypropyl(meth)acrylate, hydroxyalkyl(meth)acrylate, polyethylene glycol monoacrylate, hydroxyalkyl(meth)acrylate, polyethylene glycol mono(meth)acrylate, and polyalkylene glycol (meth)acrylate. These may be used singly or in combination.

Of water-soluble monomers, a methacrylate monomer is preferably used, and more preferably, ethylene glycol methacrylate and hydroxyethyl methacrylate are each used singly or in their combination.

In the case when an aqueous medium constituting a suspension is a mixture of water and an organic solvent, a commonly used monomer, such as n-butyl acrylate or methyl methacrylate.

Specific examples of a cross-linking monomer used as a monomer to form the cross-linking structure of a water-absorbing polymer include a compound containing at least two ethylenically unsaturated groups in the molecule, such as ethylene glycol di(meth)acrylate, diethylene glycol di(meth)acrylate, triethylene glycol di(meth)acrylate, propylene glycol di(meth)acrylate, polyethylene glycol di(meth)acrylate, trimethylolpropane tri(meth)acrylate, pentaerythritol tri(meth)acrylate, pentaerythritol di(meth)acrylate, N,N-methylenebisacrylamide, isocyanuric acid triallyl, trimethylolpropane dially ether, and tetraallyloxyethane; a compound containing an ethylenically unsaturated group and an other reactive functional group in the molecule, such as hydroxyethyl(meth)acrylate and glycidyl(meth)acrylate; a polyhydric alcohol, such as ethylene glycol, diethylene glycol, triethylene glycol, polyethylene glycol, glycerin, polyglycerin, propylene glycol, polyvinyl alcohol, pentaerythritol, sorbitol, glucose, mannitol, mannitane, saccharose, and glucose; a polyepoxy compound, such as ethylene glycol diglycidyl ether, glycerin diglycidyl ether, polyethylene glycol diglycidyl ether, propylene glycol diglycidyl ether, polypropylene glycol diglycidyl ether, neopentyglycol diglycidyl ether, 1,6-hexanediol diglycidyl ether, trimethylolpropane diglycidyl ether, trimethylolpropane triglycidyl ether and glycerin triglycidyl ether; and an alkylene carbonate. These may be used singly or in combination.

Of these cross-linking monomers, trimethylol propane tri(meth)acrylate, N,N-methylenebisacrylamide, ethylene glycol di(meth)acrylate and polyethylene glycol di(meth)acrylate are preferred.

The amount of a cross-linking monomer to be used depends on the kind of cross-linking monomer or polymerization conditions, but is preferably within the range of from 0.05 to 0.5 mole per mol of the whole monomer. An excessively small amount of a cross-linking monomer has some concerns that the obtained polymer may not stably maintain a swelling state. On the contrary, an excessively large amount of a cross-linking monomer has some concerns that the obtained polymer may not steadily subsume an intended quantity of water molecules.

### Polymerization Initiator

A polymerization initiating agent (or polymerization initiator) to be preliminarily contained in an aqueous medium may employ a light-initiating agent, a UV-initiating agent or a heat-initiating agent, and a water-soluble one is preferable. Specific examples thereof include amine-type or polyamide type epoxy resin, and more specifically, for example, 2,2-azobis[2-methyl-N-(2-hydroxyethyl)]propionamide. A curing agent which is water-insoluble or slightly water-soluble is used in a small amount or dissolved in a solvent, as an aqueous medium in which the foregoing curing agent is soluble.

The polymerization temperature is required to be within a temperature range, not causing aggregation of particles (12), and a temperature range of 50 to 90° C. is preferable.

The concentration of a monomer in an aqueous medium is preferably within a range of 5 to 50% by mass. A monomer concentration in an aqueous medium falling within the foregoing range inhibits disorder in arrangement, caused with evaporation of water molecules. On the contrary, an excessively low monomer concentration in an aqueous medium results in a reduced proportion of water molecules subsumed in a water-absorbing polymer and an increased amount of water to be removed; consequently, it is a concern that the obtained particle array results in increased disorder in particle arrangement, caused by evaporation of water molecules, leading to reduced emission of structural color. In the case of an excessively high monomer concentration in an aqueous medium, it is a concern that disorder results in the tree-dimensional position of particles arranged by polymerization of monomers.

A refractive index of a matrix formed of a water-absorbing polymer in the particle array obtained by the method described above can be determined by various methods known in the art. In the invention, the refractive index of a matrix is a value determined in such a manner that a thin film formed only of a water-absorbing polymer constituting the matrix is separately prepared and is measured by an Abbe's refractometer.

### Particle

In the invention, a particle refers to a solid substance exhibiting a three-dimensionally particle form, which is not limited to a sphere but may have an approximate particle form. A material which forms particles constituting a colloidal crystal of a particle array may optimally choose one which is water-insoluble and exhibits a refractive index differing from that of a matrix.

There are cited a variety of examples of particles constituting a colloidal crystal of the particle array of the invention. Specifically, there is cited an organic particulate material formed by polymerization of a polymerizable monomer or copolymerization of polymerizable monomers selected from examples including: styrene monomers such as styrene, methylstyrene, methoxystyrene, butylstyrene, phenylstyrene and chlorostyrene; acrylic acid ester or methacrylic acid ester monomers such as methyl acrylate, ethyl acrylate, (iso)propyl acrylate, butyl acrylate, hexyl acrylate, octyl acrylate, ethylhexyl acrylate, methyl methacrylate, ethyl methacrylate, butyl methacrylate and ethylhexyl methacrylate; and carboxylic acid monomers such as acrylic acid, methacrylic acid, itaconic acid and fumaric acid.

Such an organic particle may be one which is formed by polymerization of a crosslinking monomer, in addition to the polymerizable monomer, as cited above. Specific examples of such a crosslinking monomer include divinylbenzene, ethylene glycol dimethacrylate, tetraethylene glycol dimethacrylate and trimethylolpropane trimethacrylate.

There are also cited inorganic particles formed of an inorganic oxide, for example, silica, titanium oxide, aluminum oxide, copper oxide, barium oxide, ferric oxide, or their composite oxide; glass or ceramics.

Further, there is also cited a core/shell particle comprising a core particle of an organic particle or inorganic particle, as described above and a shell layer formed of a material different from that of the core on the surface of the core particle. Such a shell layer can be formed by using metal microparticles, metal oxide microparticles such as titania or a metal oxide nano-sheet composed of titania or the like. Further, there is also cited a hollow particle obtained by removing a core from a core/shell particle through the procedure such as calcination or abstraction. Of these particles, an organic particle is suitably used.

Particles constituting the particles array of the invention may be a single material of a single composition or a composite material. When forming a particle with a high refractive index material, a low refractive index material may be incorporated.

The average particle size of particles is required to be set in relation to the refractive index of the particles and that of a matrix, and is also preferably of such a size that its suspension is a stable colloidal solution, therefore, it is preferably from 50 to 500 nm.

When an average particle size falls within the foregoing range, a suspension becomes a stable colloidal solution and in the obtained particle array, an emitted structural color becomes a color exhibiting a peak wavelength in the range of near ultraviolet—visible—near infrared. When an average particle size is less than 50 nm, there is a concern that the reflected light intensity is small and when an average particle size is more than 500 nm, there is a concern that increased light scattering results in milky-whitening of the structural color.

A CV value expressing particle size distribution is preferably not more than 10%, more preferably not more than 5% and still more preferably not more than 3%. A CV value of more than 10% results in disorder in a particle layer to be orderly arranged and the obtained particle array becomes milky-white, rendering it difficult to perceive its structural color.

An average particle size is determined in such a manner that particles are photographed using a scanning electron microscope at a magnification of 50,000-fold (JSM-7410, produced by Nippon Denshi Co., Ltd.) and 100 particles of each of two sheets of electronmicrograph are measured with respect to maximum length to calculate a number average value. Herein, the maximum length refers to a maximum of distances between two points on the circumference of a particle. In cases when particles are photographed as an aggregate, the maximum length of primary particles forming the aggregate is measured.

The CV value is calculated by the following expression (CV):

CV value={(standard deviation)/(average particle size)]×100 Expression (CV)

where “standard deviation” is a standard deviation in a number-based particle size distribution and “average particle size” is a number average particle size.

The refractive index of a particle (12) is measured by various methods known in the art, but the refractive index in the invention is a value determined in a liquid immersion method. Examples of a refractive index include polystyrene: 1.59, poly(methyl methacrylate9: 1.49, polyester: 1.60, fluorine-modified poly(methyl methacrylate): 1.40, polystyrene-co-butadiene): 1.56, poly(methyl acrylate): 1.48, poly(butyl acrylate): 1.47, silica: 1.45, titanium dioxide (anatase type): 2.52, titanium dioxide (rutile type): 2.76, copper oxide: 2.71, aluminum oxide: 1.76, barium sulfate: 1.64 and ferric oxide: 3.08.

Particles constituting a colloidal crystal of the particle array of the invention are preferably those of enhanced monodispersibility, which are easy to be orderly arranged. In cases when particles are those of an organic material, to achieve enhanced monodispersibility, the particles are preferably made by a soap-free emulsion polymerization method, a suspension polymerization method or an emulsion polymerization method, as known in the art.

Particles may be subjected to a various surface treatments to achieve enhanced affinity to a matrix.

The concentration of particles in a suspension liquid is preferably not more than 20% by mass in terms of handling.

Coating of suspension liquid onto a substrate is conducted by employing a screen coating method, a dip-coating method, a spin-coating method, a curtain coating method, the LB (Langmuir-Blodget) membrane forming method, or the like.

A substrate to coat a suspension liquid of particles to form a particle array includes, for example, rubber, glass, and a film or sheet of polyethylene terephthalate (PET) and polyethylene naphthalate (PEN).

A substrate, of which the surface exhibits a relatively low contact angle of water, is preferable. A substrate may be subjected to a suitable surface treatment, with a relatively high surface smoothness being preferred. A substrate may also be subjected to easily adhere particles.

### Structural Color

Structural color emitted in the particle array of the invention, which is prescribed based on the observing angle, is a color obtained by selectively reflected light.

A light selectively reflected in a particle array is a light having a wavelength represented by the following expression (1), based on Bragg's rule and Snell's rule:

λ=2nD(cos θ) Expression (1)

where λ is a peak wavelength of structural color, “n” is a refractive index of a particle array, represented by the following expression (2), “D” is a spacing between particle layers or a particle layer spacing [in the vertical direction of a display member of particles (12)] as shown in FIG. 3, and “θ” is an observing angle to the perpendicular of a display member;

n=(na·c)+[nb·(1−c)] Expression (2)

Where “na” is a refractive index of a particle, “nb” is a refractive index of a matrix, and “c” is a volume factor of a particle (12) in a particle array.

Peak wavelength λ of structural color is measured by spectrocolorimeter CM-3600d (produced by Konica Minolta Sensing Inc.). The foregoing expressions (1) and (2) are each an approximate expression and there is sometimes a case which does not coincide with this calculated value.

A thickness of a particle layer in a particle array (10) of the invention is, for example, preferably from 0.1 to 15 μm. A particle layer thickness of less than 0.1 μm results in a reduced intensity of reflected light.

In the particle array of the invention, the periodicity of a particle layer needs to be one or more, and is preferably from 5 to 150. When the periodicity is one or more, the particle array emits a structural color.

A structural color achieved in the particle array of the invention is not limited to color having a peak wavelength in the visible region but may be a light having a peak wavelength in the ultraviolet region or in the infrared region.

In the particle array of the invention, a particle layer spacing, for example, as designated D in FIG. 3, is preferably from 50 to 500 nm. When a particle layer spacing falls within the foregoing range, a structural color achieved in the obtained particle array exhibits a peak wavelength falling within the region of from near ultraviolet to visible and further to near infrared. When the particle layer spacing is more than 500 nm, there is concern that the obtained particle array will not achieve any structural color.

In the production method of a particle array according to the invention, for example, as illustrated in the figures, monomers in an aqueous medium used for formation of a colloidal crystal are polymerized to fix the colloidal crystal, whereby a particle array incorporating a high quality colloidal crystal, inhibiting disorder in the array, can be obtained within a short period of time.

Specifically, the production method in which at least one water molecule per monomer molecule is subsumed within a polymer formed by polymerizing monomers, results in reduced number of water molecules to be removed, so that disorder in the particle array, which is accompanied by removal of water, is inhibited and consequently a particle array incorporating a colloidal crystal of high quality can be obtained within a short period of time.

While the embodiments of the invention have been specifically described, the embodiments of the invention are not limited to these and various changes and modifications can be made therein.

### Examples

The invention will be further described with reference to specific examples but the invention is not limited to these. In the following, an average particle size and a CV value of particles were determined according to the manner as described earlier.

### Example 1

Polystyrene particles (average particle: 200 nm, CV value: 5%) which were prepared by an emulsion polymerization method were dispersed in a deionized water to obtain 50 g of a suspension liquid having a polystyrene particle concentration of 50% by mass.

Subsequently, 10 g of a non-crosslinking monomer, hydroxyethyl methacrylate and 10 g of a crosslinking monomer, ethylene glycol diacrylate were mixed with 10 g of water to prepare a liquid mixture. Further thereto, 0.1 g of a UV polymerization initiator, 2,2′-azobis[2-methyl-N-(2-hydroxyethyl)]propionamide was added to obtain a monomer solution.

The monomer solution was mixed with the foregoing suspension and after stirring, the mixture was subjected to a hydrophilization treatment by plasma discharge to obtain a coating solution.

The coating solution was coated on a glass plate by a bar coater at a thickness of 20 μm and exposed to ultraviolet rays to polymerize monomers by drying to obtain a coated film containing a colloidal crystal. The water content of the film was measured. The film was visually observed and it was confirmed that the film exhibited a clear structural color and the state of the film surface was excellent without disorder.

Further, the film was dried in a dryer at 50° C. until no change in mass occurred, whereby a particle array (1) was obtained. The obtained particle array (1) was visually observed and it was confirmed that the particle array (1) exhibited a clear structural color and the state of the surface thereof was excellent without disorder. There was also measured the water content of the particle array (1).

Measurement of the water content of the film and the particle array (1) was conducted in the following manner. Thus, 1 g of the film or the particle array (1) was pulverized in mortar and after water was evaporated at 200° C., the water content was determined by a titration method by a Karl Fischer's reagent in Karl Fischer's aquameter (produced by Mitsubishi Chemical Co., Ltd.).

### Example 2

A particle array (2) exhibiting a structural color was obtained similarly to Example 1, except that 10 g of hydroxyethyl methacrylate was replaced by 10 of acrylamide monomer as a non-crosslinking monomer and 10 g ethylene glycol diacrylate was replaced by 10 g of methylenebisacrylamide monomer as a crosslinking monomer.

There are shown in Table 1 evaluation results of the obtained film with respect to state of the film surface, the extent of exhibited structural color and the water content, and evaluation results of the obtained particle array (2) with respect to state of the film surface, the extent of exhibited structural color and the water content.

### Example 3

A particle array (3) exhibiting a structural color was obtained similarly to Example 1, except that 10 g of hydroxyethyl methacrylate was replaced by 10 of polyethylene glycol acrylate monomer as a non-crosslinking monomer and 10 g ethylene glycol diacrylate was replaced by 10 g of methoxypolyethylene glycol acrylate monomer as a crosslinking monomer.

There are shown in Table 1 evaluation results of the obtained film with respect to state of the film surface, the extent of exhibited structural color and the water content, and evaluation results of the obtained particle array (2) with respect to state of the film surface, the extent of exhibited structural color and the water content.

### Comparative Example 1

A particle array (x) exhibiting a structural color was obtained similarly to Example 1, except that 10 g of hydroxyethyl methacrylate as a non-crosslinking monomer and 10 g ethylene glycol diacrylate as a crosslinking monomer were replaced by 20 g of a methyl methacryl monomer of a hydrophobic monomer.

There are shown in Table 1 evaluation results of the obtained film with respect to state of the film surface, extent of exhibited structural color and water content, and evaluation results of the obtained particle array (2) with respect to state of the film surface, extent of exhibited structural color and water content.

### Comparative Example 2

A particle array (x) exhibiting a structural color was obtained similarly to Example 1, except that 20 g of a methyl methacryl monomer of a hydrophobic monomer was used in the state of being emulsified by using a nonionic surfactant, Emelgen 108 (produced by KAO Co., Ltd.).

There are shown in Table 1 evaluation results of the obtained film with respect to state of the film surface, extent of exhibited structural color and water content, and evaluation results of the obtained particle array (2) with respect to state of the film surface, extent of exhibited structural color and water content.

TABLE 1

| | Evaluation Result | | | | | |
|---|---|---|---|---|---|---|
| | Film (before dried at | | Particle Array (after | | | |
| | 50° C.) | | dried at 50° C.) | | Water Content (% by mass) | |
| | Structural | | Structural | | Before Dried | After Dried |
| | Color | Surface State | Color | Surface State | at 50° C. | at 50° C. |
| Example 1 | clear | excellent | clear | excellent | 20 | 15 |
| | | without | | without | | |
| | | disorder | | disorder | | |
| Example 2 | clear | excellent | being | shrinking being | 15 | being not |
| | | without | observed | observed and | | detectable |
| | | disorder | but | inferior | | |
| | | | inferior | | | |
| Example 3 | clear | excellent | being | shrinking being | 25 | being not |
| | | without | observed | observed and | | detectable |
| | | disorder | but | inferior | | |
| | | | inferior | | | |
| Comparative | being | repellency | being | repellency | being not | being not |
| Example 1 | hardly | being formed | hardly | being formed on | detectable | detectable |
| | observed | in coating and | observed | coated side and | | |
| | | coating being | | being largely | | |
| | | not feasible | | inferior | | |
| Comparative | being | repellency | being | repellency | being not | being not |
| Example 2 | hardly | being formed | hardly | being formed on | detectable | detectable |
| | observed | in drying and | observed | coated side and | | |
| | | being largely | | being largely | | |
| | | inferior | | inferior | | |

What is claimed is:

1. A method of producing a particle array, the method comprising the steps of:
(i) allowing monodisperse particles to be arrayed in an aqueous medium containing a monomer to form a colloidal crystal exhibiting a structural color, and then
(ii) polymerizing the monomer to form a polymer.

2. The method of claim 1, wherein water is subsumed in the polymer in an amount of at least one molecule of water per molecule of the monomer.

3. The method of claim 1, wherein the monomer comprises a (meth)acrylate monomer.

4. The method of claim 1, wherein the monomer comprises a crosslinking monomer and a non-crosslinking monomer.

5. The method of claim 4, wherein the monomer comprises ethylene glycol di(meth)acrylate and hydroxyethyl methacrylate.

6. The method of claim 1, wherein in the step of (i), the monodisperse particles are dispersed in the aqueous medium containing a monomer to form a suspension and the suspension is coated on a substrate to form the colloidal crystal.

7. The method of claim 1, wherein the method further comprises subjecting the polymer to drying at a temperature lower than a softening point of the polymer so that a difference in water content (% by mass) of the polymer between before and after being dried is not more than 10% by mass.
